(19) United States
(12) Patent Application Publication
(10) Pub. No.: US 2003/0206169 A1
(43) Pub. Date: Nov. 6, 2003

(54) System, method and computer program product for automatically snapping lines to drawing elements

(76) Inventors: Michael Springer, West Chester, PA (US); Brien Bastings, Glemoore, PA (US); Gino Cortesi, Honey Brook, PA (US); Josh Schifter, Exton, PA (US)

Correspondence Address: VENABLE, BAETJER, HOWARD AND CIVILETTI, LLP, P.O. BOX 34385, WASHINGTON, DC, 20043-9998, US

(21) Appl. No.: 09/962,458

(22) Filed: Sep. 26, 2001

(51) Int. Cl. G06T 11/20

(52) U.S. Cl. 345/442

(57) ABSTRACT

The present invention can include a method in a computer system for automatically connecting drawing elements to other drawing elements, which can include selecting one or more snap modes from a set of snap modes; drawing an element in a graphics file with a cursor; moving the cursor to a position within a distance tolerance of a second drawing element; automatically determining a set of snap points from the position of the cursor, based on the selected snap modes; visually highlighting a snap point; releasing the end of the first element; and automatically connecting the end of the first element with the snap point. The method can further include any of: identifying that the cursor is in a position within a distance tolerance of a trigger location in a drawing and automatically determining a snap point from the trigger location, where the snap point location is different from the trigger location; highlighting the snap point with an icon depicting the location of the snap point and a different icon depicting the mode of the snap point; excluding one or more types of drawing elements from snap point calculations; receiving a snap point or a snap mode from another software process; prioritizing the snap modes; or sounding an auditory indication that snapping has occurred.

### BACKGROUND OF THE INVENTION

1. Field of the Invention

The present invention relates generally to software image editors and other computer graphic based applications. In particular, the present invention relates to the automatic connection of drawing elements to other drawing elements within graphics files.

2. Related Art

In the computer drawing and graphics fields, the ability to connect automatically, or “snap”, an element in a drawing to another drawing element is very useful. In conventional drawing programs, a user typically draws an element, for example, a line, by selecting a point in the drawing where the line should begin, and then by dragging or otherwise moving the cursor to the position in the drawing where the line should end. It is useful to be able to connect that second end with a previously drawn element, for example, to form a corner in a polygon or to enclose an area for filling with a pattern.

Without this snap-to ability, a user wishing to connect, for example, a line, to the middle of a line segment or the center of a circle would have to position the end of the line in the exact place the user wanted the end of the line to go. It can be difficult to identify the exact point. In addition, the precision required, for example, in a computer aided design (CAD) environment or an engineering project, may be too great with respect to the user's ability to move the cursor to an exact point. In CAD projects, incorrect line placement in a drawing can mean incorrect dimensions in a building or in a machine component, costing considerable time and money to repair after the drawing stage. With snap-to ability, however, the user can simply let go of the end of the new line near the desired connection point and the line-end connects automatically to a specified snap point on the nearest element.

Typically, snap points are found on an element-by-element basis. As the cursor nears a drawing element, such as a line representing a wall, one or more of the possible snap points on that element are identified by the software and displayed to the user. Potential snap points on other drawing elements are not identified unless the user places the cursor closer to those elements.

There are many types of snap points conventionally available, as illustrated in FIGS. 1A-N. FIG. 1A shows a projection snap point. Here, a line is drawn by placing a first point 102a, then moving the cursor 104a to place the other end of the line. The projection snap point 106a is simply the point on element 108 nearest the end of the line being drawn.

In key-point snap point mode as shown in FIG. 1B, a drawing element is divided into segments 110a, 110b, 110c. The key-point snap point 106b occurs at the junction of the segments 110a, 110b closest to the cursor 104b drawing the line beginning at point 102b. Although the position of cursor 104b defines line 112a, after snapping, the line actually drawn will be line 112b.

In midpoint snap mode as shown in FIG. 1C, the snap point 106c is located at the middle of a line segment 114. As cursor 104c draws a line 116a from starting point 102c, the actual resultant line after snapping will be line 116b. Note that midpoint snap points occur only at the midpoint of line segments, not at the middle of two or three-dimensional shapes.

FIG. 1D shows a bisecting snap point 106d, which is located at the absolute bisector of an element 118. As cursor 104d draws a line 120a from starting point 102d, the resultant line, after snapping, will be line 120b to the bisecting snap point 106d. In most cases, the bisecting snap point occurs at the same position as that of a midpoint snap point, but in the case of a line string (a line with two or more segments), the bisecting snap point occurs at the midpoint of the overall line string while a midpoint snap point occurs at the midpoint of each individual segment.

A center snap point 106e, shown in FIG. 1E, locates the centroid of an arc 116. As cursor 104e draws a line 124a from starting point 102e, the actual resultant line after snapping will be line 124b. A center snap point can be also at the center of a circle, or the centroid of a line string.

An origin snap point is used to determine the “origin” or starting point of an element. In the case of circles, the snap point is the center. In the case of text, it is the justification point. In the case of lines, line strings, curves, shapes, and other drawing elements, it is the first point that describes the element. FIG. 1F shows origin snap point 106f at the origin of element 126, which is made of several line segments. As cursor 104f draws a line 128a from starting point 102f, the resultant line, after snapping, will be line 128b.

The intersection of two drawing elements can also be a snap point, as shown in FIG. 1G. Here, the cursor 104g draws a line 134a beginning at point 102g. When the cursor is near the intersection of elements 130 and 132, snap point 106g is shown. After snapping, the resultant line will be line 134b.

A point that makes the line being drawn parallel to another line segment is a parallel snap point, as shown in FIG. 1H. As cursor 104h draws a line 138a from starting point 102h, the resultant line 138b is constrained to be parallel to line segment 136.

Tangent lines to arcs and circles can be made from three different snap point modes: tangent from a fixed point, tangent from a floating point, and tangent to an element. In the case of tangent from a fixed point shown in FIG. 1I, the first line point 102i is selected on a circle 140 (or an arc). This first point does not change. As the user goes to complete the line by moving cursor 104i along path 142a, the second point is constrained to be on the line 142b that is tangent to the circle 140 at the first point 102i. It is possible in this case for the second point and the cursor to be in different places in the drawing.

In the case of tangent from a floating point in FIG. 1J, the first point 102j placed on the circle 144 (or arc) is not fixed. Instead, as the user moves the cursor 104j along path 146a, the first point is moved to position 148 on the circle 144 to maintain the tangency of the line to the element. The resultant line 146b ends at snap point 106j, but begins at a different point than that originally indicated by the user.

The tangent to an element snap mode shown in FIG. 1K has a first point 102k that is fixed somewhere in space. The snap point 106k is on the selected element 150 and is calculated such that it describes a tangent line 152b with the selected element. Again, the path 152a of the cursor 104k does not necessarily become the line drawn.

Perpendicular lines to drawing elements can be made from three different snap point modes: perpendicular from a fixed point, perpendicular from a floating point, and perpendicular to an element. In the case of perpendicular from a fixed point shown in FIG. 1L, the first line point 102l is selected on a line segment 154. This first point does not change. As the user goes to complete the line by moving cursor 104l along path 156a, the second point is constrained to be on the line 156b that is perpendicular to the line segment 154 at the first point 102l. It is possible in this case for the second point and the cursor to be in different places in the drawing.

In the case of perpendicular from a floating point in FIG. 1M, the first point 102m placed on the line segment 158 is not fixed. Instead, as the user moves the cursor 104m along path 162a, the first point is moved to position 160 on the line segment 158 to maintain the perpendicularity of the line to the element. The resultant line 162b ends at snap point 106m, but begins at a different point than that originally indicated by the user.

The perpendicular to an element snap mode shown in FIG. 1N has a first point 102n that is fixed somewhere in space. The snap point 106n is on the selected element 164 and is calculated such that it describes a perpendicular line 166b with the selected element. Again, the path 166a of the cursor 104n does not necessarily become the final line drawn.

In conventional snap-to implementations, the user typically has to indicate in some manner that the particular drawing element is desired as the snap location, for example, by clicking a “tentative” button or by hovering the cursor over the element for some minimum length of time. Then the user has to accept that snap point in a separate step, for example, by clicking an “accept” button. This is time consuming, adds steps to the process, and interrupts the work flow for the user.

In conventional systems that offer different snapping modes, the user is limited to one snap mode at a time. Switching between modes for each new line is also disruptive to work flow.

When the desired snap point is not actually located on the drawing element, such as, e.g. the center of a circle, conventional solutions break down. The user is typically required first to register interest in the drawing element in question, usually by selecting it or hovering the cursor over it. Then the user must find the center of the drawing element without the assistance of the drawing program. This can lead to inaccuracies in the drawings.

Another drawback to conventional systems is that the user is typically required to be very close to the snap point in order for it to register. This system breaks down when the drawing becomes crowded with elements. The snap point can be very difficult to find if there are a lot of other drawing elements, each with their own set of snap points, in the way.

Text elements conventionally have only one point to snap to. This can be problematic if the user needs to draw multiple lines to the same textual element from different places in the drawing. This can lead to lines crossing over or behind the text element, making the drawing difficult to understand. FIG. 2A shows an embodiment 200a of a conventional text element 204 with lines 208a-i snapped to it from elements 206a-i. All the lines snap to the same point 202, making the text difficult to read.

With conventional snap point systems, every element in a drawing is a candidate for having snap points. However, there are often situations where the user never wants to snap to a particular type of element, such as, e.g. dimension markings, text labels or b-spline curves. As the user brings the line-drawing cursor close to one of these elements, snap points for that element are still calculated and shown, often at the expense of showing the desired snap point.

What is needed then is a way to decrease the accuracy and precision required of the user while also allowing more customization of the snap point location system that overcomes shortcomings of conventional solutions.

### SUMMARY OF THE INVENTION

In an exemplary embodiment of the present invention a system, method and computer program product for automatically snapping lines to drawing elements is disclosed.

An exemplary embodiment of the present invention can include a method in a computer system of connecting a drawing element automatically to another drawing element in a graphics file, including selecting one or more snap modes from a set of snap modes, drawing an element in a graphics file with a cursor, moving the cursor to a position within a distance tolerance of a second drawing element, automatically determining a set of snap points from the position of the cursor, based on the selected snap modes, visually highlighting one or more snap points of the selected snap modes, releasing the end of the first element, and automatically connecting the end of the first element to the snap point.

In an exemplary embodiment, the method can further include selecting from a set of snap modes that includes projection, key-point, mid-point, bisection, center, origin, intersection, parallel, tangent from a floating point, tangent from a fixed point, tangent to an element, perpendicular from a floating point, perpendicular from a fixed point, and perpendicular to an element.

In an exemplary embodiment the method can further include snapping to a second drawing element which is a text element having at least two points to which an element can be snapped.

In an exemplary embodiment the method can further include moving the cursor to a position within a distance tolerance of a trigger location in a drawing, and automatically determining a snap point from the trigger location, where the snap point location is different from the trigger location.

In an exemplary embodiment the method can further highlighting a snap point with an icon depicting the location of the snap point and a second icon depicting the snap point's snap mode.

In an exemplary embodiment the method can further include selecting at least one type of drawing element to exclude from snap point calculations. The type of excluded drawing element can include text elements, b-spline curves and a dimension notations.

In an exemplary embodiment the method can further include receiving a snap point or a snap mode from another software process.

In an exemplary embodiment the method can further include assigning a priority to each of the selected snap modes, and assigning a different priority to the snap point or a snap mode received from another software process.

In an exemplary embodiment the method can further include sounding an auditory indication that snapping has occurred.

In an exemplary embodiment the method can further include assigning a priority to each of the selected snap modes, and visually highlighting a snap point having the highest priority closest to the cursor.

In another exemplary embodiment, the present invention can include a system that identifies and connects snap points to drawing elements including a processor, a memory coupled to the processor, and a snap point identification and connection module executable on the processor operative to identify and connect snap points to drawing elements. In an exemplary embodiment, the snap point identification and connection module can include a selector operative to select at least two snap modes from a set of snap modes, a graphics editor operative to draw a first element in a graphics file with a cursor and to move the cursor to a position within a distance tolerance of a second drawing element, a snap point generator that automatically determines a set of snap points from the position of the cursor, based on the selected snap modes, a display module that visually highlights at least one snap point of the set of snap points, and a snapping module that automatically connects the end of the first element with the snap point.

In an exemplary embodiment, the system can further include any of: a trigger sensor that identifies when the cursor is in a position within a distance tolerance of a trigger location in a drawing and where the snap point generator automatically determines a snap point from the trigger location, where the snap point location is different from the trigger location; a snap point display that highlights the snap point with a first icon depicting the location of the snap point and a second icon depicting the snap point's snap mode; a snap point excluder operative to select at least one type of drawing element to exclude from snap point calculations; a snap point receiver that receives a snap point or a snap mode from another software process; a prioritizer operative to assign a priority to the selected snap modes; an audio signaler that sounds an auditory indication that snapping has occurred; a text drawing element including at least two points to which an element can be snapped; and where the set of snap modes can include projection, key-point, mid-point, bisection, center, origin, intersection, parallel, tangent from a floating point, tangent from a fixed point, tangent to an element, perpendicular from a floating point, perpendicular from a fixed point, and perpendicular to an element.

In another exemplary embodiment, the present invention can include a computer program product embodied on a computer readable medium, where the computer program product can include program logic including code means for snap point identification and connection to drawing element. The snap point identification and connection code means can include selection means for selecting at least two snap modes from a set of snap modes, drawing means for drawing an element in a graphics file with a cursor and for moving the cursor to a position within a distance tolerance of a second drawing element, snap point generating means for automatically generating a set of snap points from the position of the cursor, based on the selected snap modes, display means for visually highlighting a snap point of the set of snap points, and snapping means for automatically connecting the end of the first element with the snap point.

In an exemplary embodiment, the computer program product can further include any of: trigger means for identifying when the cursor is in a position within a distance tolerance of a trigger location in a drawing, where the snap point generating means automatically generates a snap point from the trigger location, and where the snap point location different from the trigger location. In an exemplary embodiment, the computer program product can further include snap point display means for highlighting the snap point with an icon depicting the location of the snap point and a second icon depicting the snap point's snap mode, snap point excluding means for selecting and a type of drawing element from snap point calculations, snap point receiving means for a snap point or a snap mode from another software process, snap point prioritization means for assigning a priority to the selected snap modes, audio signaling means for sounding an auditory indication that snapping has occurred, text drawing element snapping means for providing at least two points to which an element can be snapped, and snap mode means for snapping including projection, key-point, mid-point, bisection, center, origin, intersection, parallel, tangent from a floating point, tangent from a fixed point, tangent to an element, perpendicular from a floating point, perpendicular from a fixed point, and perpendicular to an element.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left-most digits in the corresponding reference number indicate the drawing in which an element first appears.

FIGS. 1A-N depict conventional examples of snap point modes;

FIG. 2A depicts a conventional embodiment of a text element snap point;

FIG. 2B depicts an exemplary embodiment of a text elements with multiple snap points according to the present invention;

FIGS. 3A-B depict two exemplary embodiments of dual points used to determine snap points according to the present invention;

FIGS. 4A-B depict two exemplary embodiments of snap mode icons;

FIG. 5 depicts a block diagram of an exemplary system according to the present invention; and

FIG. 6 depicts an exemplary embodiment of a computer system that could be used in the present invention.

### DETAILED DESCRIPTION OF AN EXEMPLARY EMBODIMENT OF THE PRESENT INVENTION

A preferred embodiment of the invention is discussed in detail below. While specific exemplary embodiments are discussed, it should be understood that this is done for illustration purposes only. A person skilled in the relevant art will recognize that other components and configurations can be used without parting from the spirit and scope of the invention.

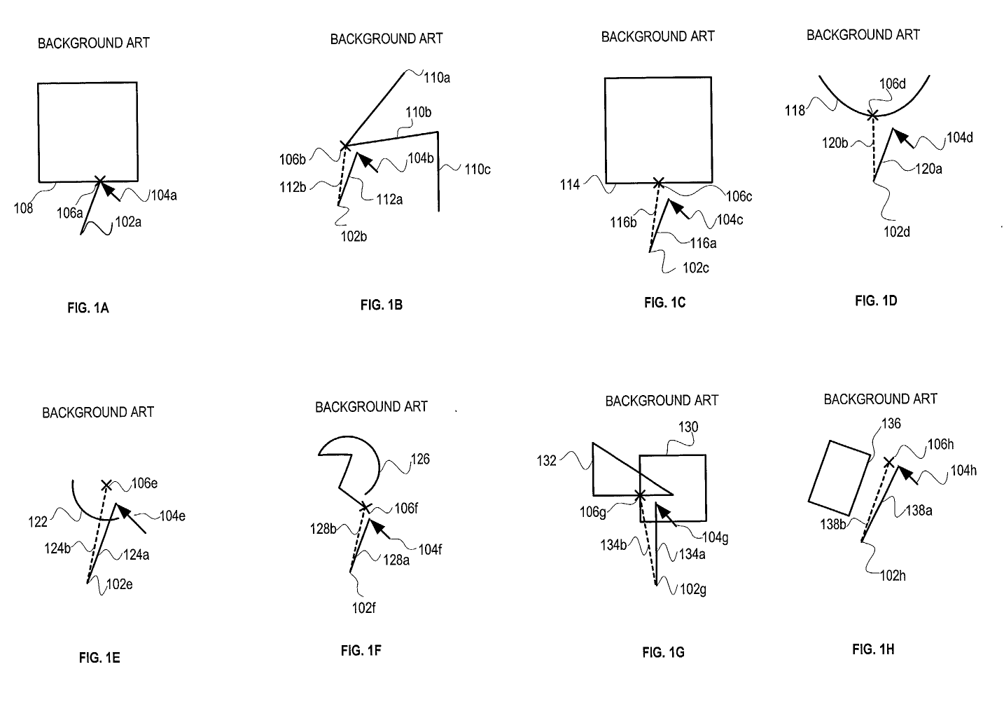

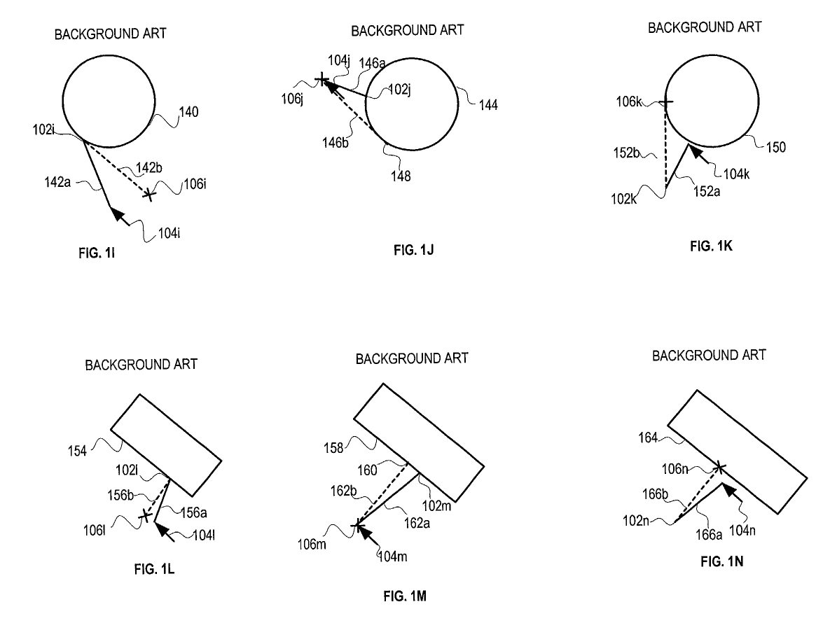

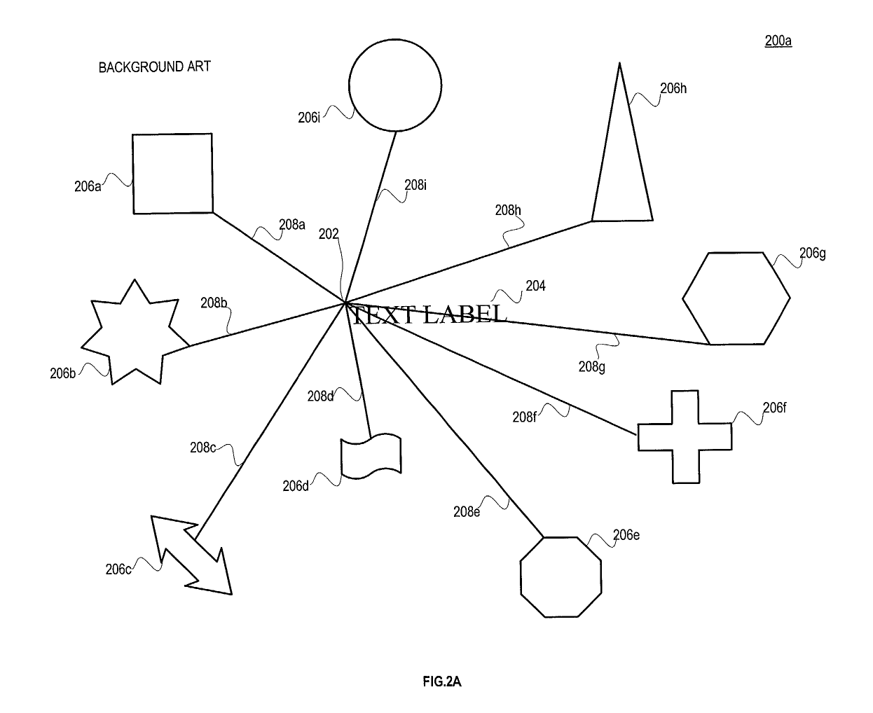

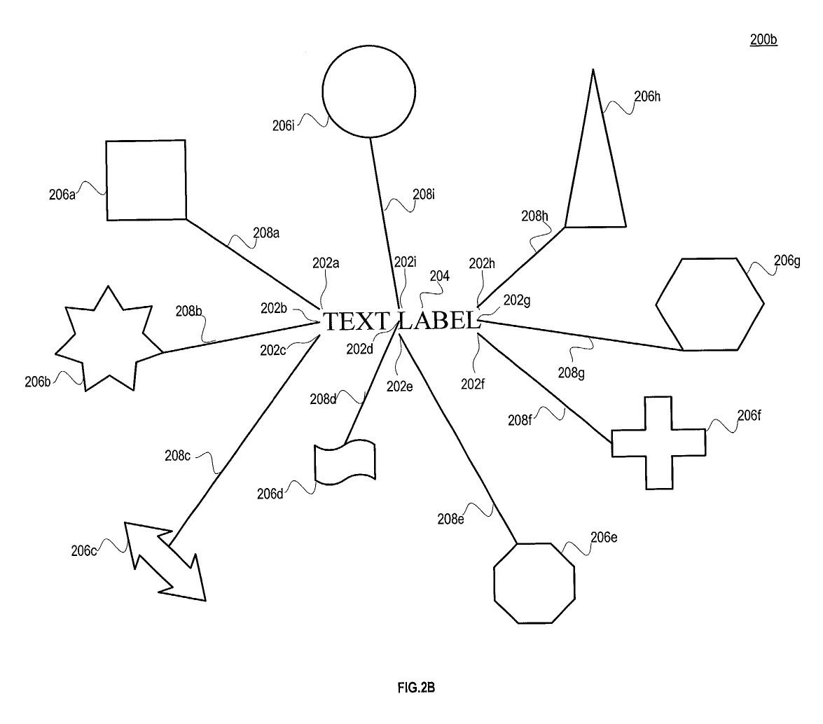

FIGS. 1 and 2A were discussed above in the Related Art section.

FIG. 2B shows an exemplary embodiment of a text element in the present invention. In this embodiment, text element 204 has nine snap points 202a-i. This allows the nine lines 208a-i drawn to text element 204 to be distributed across the text more evenly. The text is more readable in the drawing and the lines 208 are easier to trace to their referenced elements.

In an exemplary embodiment of the present invention, snap points can have a priority assigned to them. For example, if the user wishes to snap to the center of an element, the user can set the priority of the center snap mode higher than any other priority. Prioritizing multiple snap modes allows for the capability of providing more than one snap mode at a time to the user, which is discussed further below.

In an exemplary embodiment of the present invention, snap points are calculated on a point-by-point basis, rather than an element-by-element basis. This makes it possible to find the highest priority snap point, even if that snap point is not on the closest element.

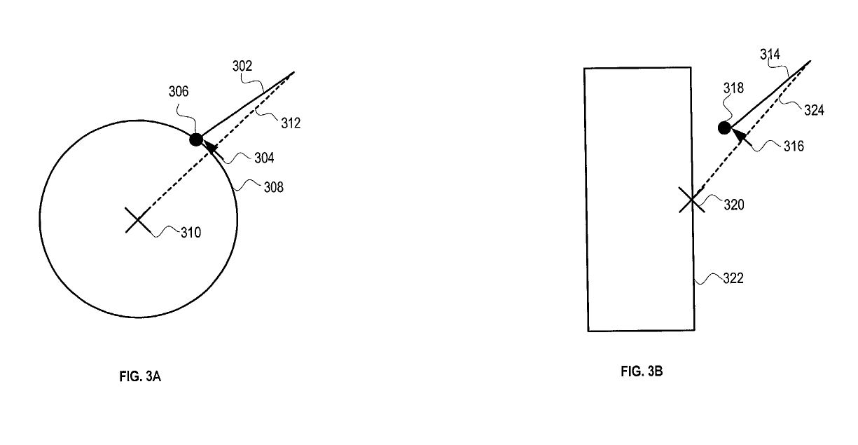

Another feature of the present invention is the use of two points in the proximity calculation, a primary and a secondary point, in locating snap points. The primary point is the actual snap point, while the secondary point is a trigger point. In one example, shown in FIG. 3A, any point 306 on a circle 308 can be a secondary point. As the cursor 304 draws a line 302 towards the circle 308, proximity of the cursor 304 to a point 306 on the circle triggers the activation of the primary snap point 310 at the circle's center. In that case, the user needs only to place the cursor over the circle perimeter in order to find and snap to the circle's center. This saves a great deal of time and avoids interrupting the user's work flow.

FIG. 3B shows another example of the use of two points in the proximity calculation. Here, the secondary point can be any user-defined point, and does not have to be on the geometry of the element being snapped to. The secondary point 318 could, for example, be specified to be a set distance away from an element 322, e.g. four feet from a wall (represented by, e.g., a line). Once the user moves the cursor 316 along a path 314 to a point 318 in that trigger area, the line 324 can snap to a point 320 on the wall, specified by a chosen snap mode, automatically.

In an exemplary embodiment, the user can select multiple snap modes at once. As the user draws a line, the snap point of highest priority that is closest to the cursor becomes the active snap point. This allows the user to make use of different types of snap points without having to change snap modes within the system. The user's work flow therefore is not interrupted, saving time and effort.

In an exemplary embodiment having multiple snap modes, there can be two different kinds of visual feedback for the user regarding the snap points. In an exemplary embodiment, one type of visual feedback, such as an icon, shows the position of a snap point in a drawing. In an exemplary embodiment, a different type of visual feedback, such as a separate icon, shows the mode of a snap point.

At any given point, an element according to the present invention exists in one of three possible states: 1) not snapped, not near an element (indicated by the lack of any icons on the view window); 2) not snapped, near an element (indicated by icons showing the location and type of the best snap point); and 3) snapped (indicated by different icons showing the location of the snap point and type of point). In all of these cases, the cursor can be independent of the snap system, that is, the cursor can be moved around freely. However, the location of the cursor as seen by the snap system (for placement, modification, etc.) can depend on the state of the snap system. When in the snapped state, the snap system can use the snap point as the position of the cursor.

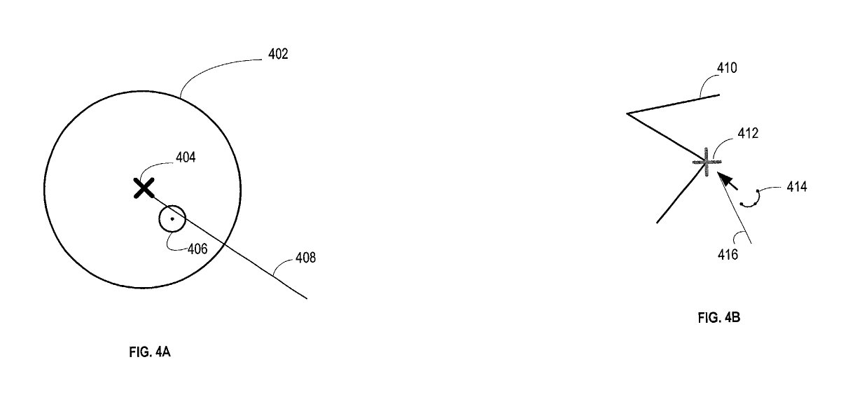

FIG. 4A depicts an example of the snapped state (state 3). Line 408 has been drawn to circle 402. The “X” shape of icon 404 indicates to the user that the line 408 has been snapped to the location of icon 404, in this case, the center of circle 402. Icon 406 shows that the snap mode of the snap point is center snap.

FIG. 4B shows the “not snapped, but near an element” state (state 2). Line 416 is being drawn toward element 410. The icon 412, in this example a “plus” sign, shows the location of the nearest key-point snap point. The fact that the icon is a “plus” and not an “X” tells the user that the line has not yet been snapped. Additionally, icon 414 shows that the current snap mode is key-point snap. When there are no elements near the line being drawn, i.e. in the “not snapped, not near an element” state (state 1), only the ordinary system cursor is visible.

In an exemplary embodiment, the user can elect to ignore drawing elements, such as, e.g., text, dimension markings or b-spline curves, when locating snap points. This means that these ignored elements are not considered in the calculation of snap points. Snap points will therefore only exist on elements to which the user may want to snap. This is useful in drawings where elements the user does not want to snap to are close to desired elements.

In an exemplary embodiment of the present invention, external software processes can make use of the snapping capability of the present invention. These external software processes are usually design editors. The present invention allows these external software processes to create snap modes and snap points in design files. If the user then wishes to edit or otherwise work with the design file within the present invention, those externally created snap points and snap modes are valid within the software process of the present invention.

In an exemplary embodiment of the present invention, the user is informed by a sound that the line being drawn has been snapped to a point. This is useful when visual confirmation of a successful snap operation is difficult, such as in a crowded drawing.

In an exemplary embodiment of the present invention, all snap points for a cursor's location are calculated, not just the snap points on the closest element. This feature gives the user more choices while drawing, improving work flow.

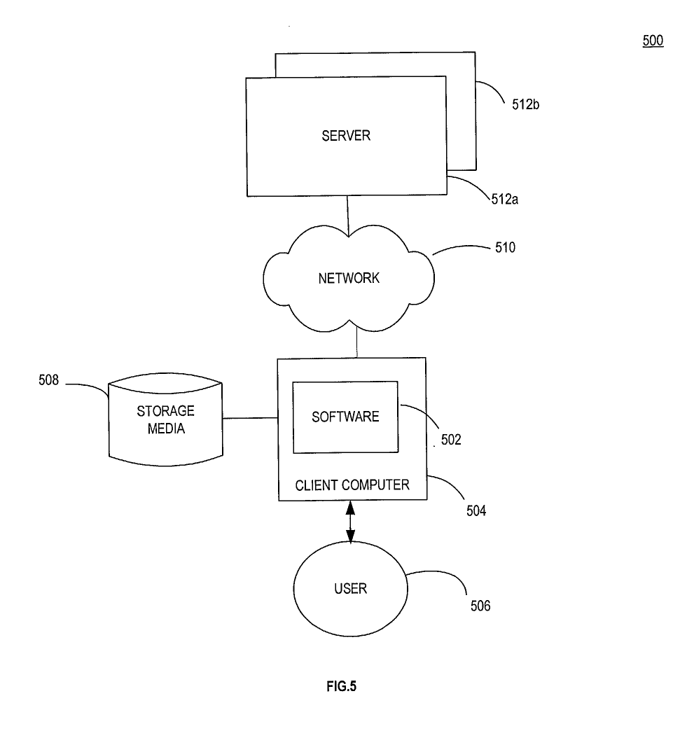

FIG. 5 depicts a block diagram 500 of an exemplary system according to the present invention. Block diagram 500 can include a user 506 interacting with a client computer 504 to access content on storage media 508 and servers 512a, 512b. Client computer 504 can include an operating system (not shown) and software application programs 502. Client computer 504 can be coupled in an exemplary embodiment to server 512a, 512b by network 510.

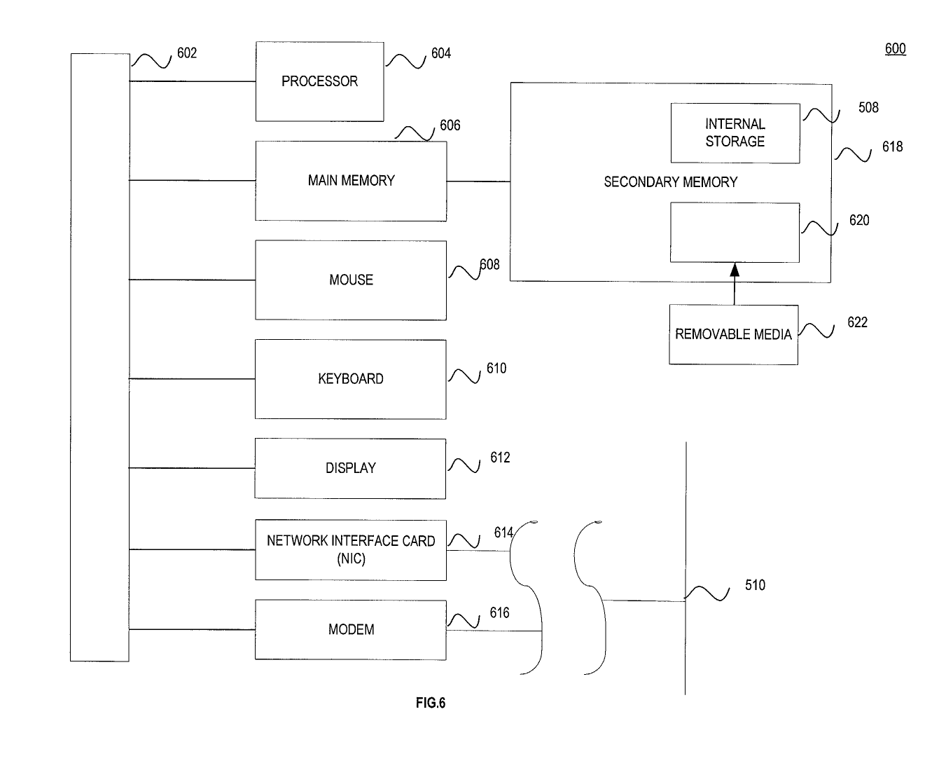

FIG. 6 depicts an exemplary embodiment of a computer system 600 that could be used in the present invention. Specifically, FIG. 6 illustrates an exemplary embodiment of a computer 502, 512 which in a preferred embodiment is a computer that can include, e.g., a personal computer (PC) system running an operating system such as, e.g., Windows NT/98/2000/CE, OS/2, MacOS, LINUX, or other variants of the UNIX operating system. However, the invention is not limited to these platforms. The invention can be implemented on any appropriate computer system running any appropriate operating system, such as Solaris, Irix, Linux, HPUX, OSF, Windows 98, Windows NT, OS/2, MacOS, and any others. In one embodiment, the present invention is implemented on a computer system operating as discussed herein.

The computer 502, 512 includes one or more processors, such as processor 604. The processor 604 is connected to a communication bus 602. The computer 502, 512 can also include a main memory 606, preferably random access memory (RAM), and a secondary memory 618. The secondary memory 618 can include, e.g., internal storage 508, or storage area network (SAN) and/or a removable storage drive 620, representing a floppy diskette drive, a magnetic tape drive, a compact disk drive, etc. The removable storage drive 620 reads from and/or writes to a removable storage unit 622 in a well known manner.

Removable storage unit 622, also called a program storage device or a computer program product, represents a floppy disk, magnetic tape, compact disk, etc. The removable storage unit 622 includes a computer usable storage medium having stored therein computer software and/or data, such as an object's methods and data.

The computer 502, 512 also includes an input device such as (but not limited to) a mouse 608 or other pointing device such as a digitizer, and a keyboard 610 or other data entry device.

The computer 502, 512 can also include output devices, such as, e.g., display 612. The computer 502, 512 can include input/output (I/O) devices such as, e.g., network interface cards 614 and modem 616.

Computer programs (also called computer control logic), including object oriented computer programs, are stored in main memory 606 and/or the secondary memory 618 and/or removable storage units 622, also called computer program products. Such computer programs, when executed, enable computer 502, 512 to perform the features of the present invention as discussed herein. In particular, the computer programs, when executed, enable the processor 604 to perform the features of the present invention. Accordingly, such computer programs represent controllers of the computer system 604, 502, 512.

In another embodiment, the invention is directed to a computer program product comprising a computer readable medium having control logic (computer software) stored therein. The control logic, when executed by the processor 604, causes the processor 604 to perform the functions of the invention as described herein.

In yet another embodiment, the invention is implemented primarily in hardware using, e.g., one or more state machines. Implementation of these state machines so as to perform the functions described herein will be apparent to persons skilled in the relevant arts.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method in a computer system of connecting a drawing element automatically to another drawing element in a graphics file, comprising:
selecting at least two snap modes from a set of snap modes,
drawing a first element in a graphics file with a cursor;
moving said cursor to a position within a distance tolerance of a second drawing element;
automatically determining a set of snap points from said position of said cursor, based on said selected snap modes;
visually highlighting at least one snap point of said set of snap points;
releasing the end of said first element; and
automatically connecting said end of said first element with said snap point.

2. The method of claim 1, wherein said set of snap modes comprises at least one of:
projection;
key-point;
mid-point;
bisection;
center;
origin;
intersection;
parallel;
tangent from a floating point;
tangent from a fixed point;
tangent to an element;
perpendicular from a floating point;
perpendicular from a fixed point; and
perpendicular to an element.

3. The method of claim 1, wherein said second drawing element comprises a text element having at least two points to which an element can be snapped.

4. The method of claim 1, further comprising:
moving said cursor to a position within a distance tolerance of a trigger location in a drawing; and
automatically determining a snap point from said trigger location, wherein said snap point is located at a different location in said drawing from said trigger location.

5. The method of claim 1, wherein each snap point is highlighted with at least one of a first icon depicting the location of said snap point and a second icon depicting said snap point's snap mode.

6. The method of claim 1, further comprising selecting at least one type of drawing element to exclude from snap point calculations.

7. The method of claim 6, wherein said type of excluded drawing element comprises at least one of a text element, a b-spline curve and a dimension notation.

8. The method of claim 1, wherein at least one of a snap point and a snap mode can be received from another software process.

9. The method of claim 8, further comprising assigning a priority to each of said selected snap modes, and assigning a different priority to said at least one of a snap point and a snap mode received from another software process.

10. The method of claim 1, further comprising sounding an auditory indication that snapping has occurred.

11. The method of claim 1, further comprising assigning a priority to each of said selected snap modes, and visually highlighting a snap point having the highest priority closest to said cursor.

12. A method in a computer system of connecting an element automatically to a drawing element in a graphics file, comprising:
selecting at least one snap mode from a set of snap modes,
drawing a first element in a graphics file with a cursor;
moving said cursor to within a distance tolerance of a trigger location in a drawing;
automatically determining a snap point from said trigger location, wherein said snap point is located at a different location in said drawing from said trigger location;
visually highlighting said snap point;
releasing the end of said first element; and
automatically connecting said end of first element with said snap point.

13. The method of claim 12 wherein said set of snap point modes comprises at least one of:
projection;
key-point;
mid-point;
bisection;
center;
origin;
intersection;
parallel;
tangent from a floating point;
tangent from a fixed point;
tangent to an element;
perpendicular from a floating point;
perpendicular from a fixed point; and
perpendicular to an element.

14. The method of claim 12, further comprising selecting at least two snap modes from said set of snap modes.

15. The method of claim 14, further comprising assigning a priority to each of said selected snap modes, and visually highlighting the snap point having the highest priority closest to said cursor.

16. The method of claim 12, wherein each snap point is highlighted with at least one of a first icon depicting the location of said snap point and a second icon depicting said snap point's snap mode.

17. The method of claim 12, further comprising selecting at least one type of drawing element to exclude from snap point calculations.

18. The method of claim 17, wherein said type of excluded drawing element comprises at least one of a text element, a b-spline curve and a dimension notation

19. The method of claim 12, wherein at least one of a snap point and a snap mode can be received from another software process.

20. The method of claim 19, further comprising assigning a priority to said selected snap mode, and assigning a different priority to said at least one of a snap point and a snap mode received from another software process.

21. The method of claim 12, further comprising sounding an auditory indication that snapping has occurred.

22. A system that identifies and connects snap points to drawing elements comprising:
a processor;
a memory coupled to said processor;
a snap point identification and connection module executable on said processor operative to identify and connect snap points to drawing elements, wherein said snap point identification and connection module comprises:
a selector operative to select at least two snap modes from a set of snap modes;
a graphics editor operative to draw a first element in a graphics file with a cursor and to move said cursor to a position within a distance tolerance of a second drawing element;
a snap point generator that automatically determines a set of snap points from said position of said cursor, based on said selected snap modes;
a display module that visually highlights at least one snap point of said set of snap points; and
a snapping module that automatically connects said end of said first element with said snap point.

23. The system of claim 22, further comprising at least one of:
trigger sensor that identifies when said cursor is in a position within a distance tolerance of a trigger location in a drawing; and wherein said snap point generator automatically determines a snap point from said trigger location, wherein said snap point is located at a different location in said drawing from said trigger location;
a snap point display that highlights said snap point with at least one of a first icon depicting the location of said snap point and a second icon depicting said snap point's snap mode;
a snap point excluder operative to select at least one type of drawing element to exclude from snap point calculations;
a snap point receiver that receives at least one of a snap point and a snap mode from another software process;
a prioritizer operative to assign a priority to said at least two selected snap modes;
an audio signaler that sounds an auditory indication that snapping has occurred;
a text drawing element comprising at least two points to which an element can be snapped; and
a set of snap modes comprising at least one of:
projection;
key-point;
mid-point;
bisection;
center;
origin;
intersection;
parallel;
tangent from a floating point;
tangent from a fixed point;
tangent to an element;
perpendicular from a floating point;
perpendicular from a fixed point; and
perpendicular to an element.

24. A computer program product embodied on a computer readable medium, said computer program product comprising program logic wherein the computer program product comprises:
code means for snap point identification and connection to drawing elements, wherein said snap point identification and connection code means comprises:
selection means for selecting at least two snap modes from a set of snap modes;
drawing means for drawing a first element in a graphics file with a cursor and for moving said cursor to a position within a distance tolerance of a second drawing element;
snap point generating means for automatically generating a set of snap points from said position of said cursor, based on said selected snap modes;
display means for visually highlighting at least one snap point of said set of snap points; and
snapping means for automatically connecting said end of said first element with said snap point.

25. The computer program product of claim 24, further comprising at least one of:
trigger means for identifying when said cursor is in a position within a distance tolerance of a trigger location in a drawing; and wherein said snap point generating means automatically generates a snap point from said trigger location, wherein said snap point is located at a different location in said drawing from said trigger location;
snap point display means for highlighting said snap point with at least one of a first icon depicting the location of said snap point and a second icon depicting said snap point's snap mode;
snap point excluding means for selecting and excluding at least one type of drawing element from snap point calculations;
snap point receiving means for receiving at least one of a snap point and a snap mode from another software process;
snap point prioritization means for assigning a priority to said at least two selected snap modes;
audio signaling means for sounding an auditory indication that snapping has occurred;
text drawing element snapping means for providing at least two points to which an element can be snapped; and
snap mode means for snapping comprising at least one of:
projection;
key-point;
mid-point;
bisection;
center;
origin;
intersection;
parallel;
tangent from a floating point;
tangent from a fixed point;
tangent to an element;
perpendicular from a floating point;
perpendicular from a fixed point; and
perpendicular to an element.
